(19) United States
(12) Patent Application Publication
(10) Pub. No.: US 2009/0138284 A1
(43) Pub. Date: May 28, 2009

(54) Integrated Record System and Method

(75) Inventors: Dean Guadagna, Boca Raton, FL (US); Jonathan Jurist, Miami, FL (US)

Correspondence Address: LERNER GREENBERG STEMER LLP, P O BOX 2480, HOLLYWOOD, FL, 33022-2480, US

(73) Assignee: HYBRID MEDICAL RECORD SYSTEMS, INC., Miami, FL (US)

(21) Appl. No.: 12/271,450

(22) Filed: Nov. 14, 2008

Related U.S. Application Data
(60) Provisional application No. 60/987,872, filed on Nov. 14, 2007.

(51) Int. Cl. G06Q 50/00; G06F 17/00; H04N 1/00; G06K 9/00; G09B 19/00

(52) U.S. Cl. 705/3; 715/222; 358/403; 382/187; 382/181; 434/262

(57) ABSTRACT

An integrated records system and method is provided that permits rapid encounter recording via a simplified, customized, flexible encounter form uniquely generated on a per-customer basis, and additionally providing unique hand-written and/or dictated impressions. In the case of medical records, the system can be used to generate patient specific encounter forms for use during a patient visit.

### CROSS-REFERENCE TO RELATED APPLICATION

The present application claims priority from U.S. Patent Application Ser. No. 60/987,872, filed on Nov. 14, 2007, entitled MEDICAL RECORD SYSTEM AND METHOD, that application being incorporated herein by reference in its entirety.

### BACKGROUND OF THE INVENTION

1. Field of the Invention

The invention relates to the field of record management systems, and more particularly, to a system for facilitating the gathering of information and for the generation and storage of integrated records, for example, medical records.

2. Description of Related Art

A patient's visit to a medical office has several stages that could be greatly enhanced by automation. The actual doctor patient interaction, however, is a ritualized and highly refined occurrence that most physicians and patients feel comfortable with as is. Electronic medical records systems have been implemented in recent years to enable doctors' offices to gain efficiencies such as faster patient record tracking, standardized encounter forms for faster patient encounter recording, as well as automated distribution of prescriptions and insurance documents. These systems come in two general iterations: pull-down menus and pick-list generators.

The pull-down menu systems allow a doctor or other caregiver to record patient encounters by tapping a designated area on a touch-sensitive tablet input device, or clicking with a mouse at a terminal or on a notebook computer. Some later systems employed personal data assistant devices (Palm Pilot or Windows Mobile systems, for example) to enter the pull-down menu choices. This convention, while efficient for entering standardized choices, lacks the unique impressions that each patient inevitably gives the caregiver at each encounter. It is likely, therefore, to “chart” every 65+ year-old COPD patient as if they were the same person. This is not medically, legally or ethically sound. It also typically requires the implementation of a technology device at the point of encounter for the doctor. This brings the inevitable fallibility of computers, tablets, touch-screens, and PDAs into play, potentially causing loss of an encounter, a day's encounters, or an entire year's data. By definition and design, the doctor must input computer choices while examining the patient, which usurps the intimate, traditional doctor-patient encounter paradigm.

Existing pick-list systems can either be designed to generate a pick-list form on a per-patient basis (choices dictated by the patient's most recent condition and diseases), or be simplified to a standardized list of choices specific to a particular specialty's common encounters. A dermatologist, for example, may have a diagnosis pick-list that has simple choices such as acne, dermatitis, shingles, psoriasis, poison ivy, or seborrhea. This potentially paper-based system can maintain the traditional charting experience for doctor and patient, but lacks flexibility and the unique qualities of each individual encounter, as described above. Electronic pick-list systems require technology devices and the inherent problems described above, as well.

There is a need for a comprehensive system with flexible data routing, traditional input methods, customized output, patient education generation, simultaneous paper/electronic file maintenance, file tracking, rapid input, real-time encounter entry, encounter correction and updating capabilities, and protection from down-coding that occurs due to incomplete encounter recording.

### SUMMARY OF THE INVENTION

An integrated records system and method is provided that permits rapid encounter recording via a simplified, customized, flexible encounter form uniquely generated on a per-customer basis, yet serving as a vessel for unique hand-written and/or dictated impressions that are the essence of accurate customer care.

In one particular embodiment of the present invention, the system breaks down the key components of each customer encounter into customized, office and station-specific groups of data and distributes the information in a timely and easily tracked system. The system and method of the present invention can be used by a service provider to correct and update the electronic records of each customer quickly and efficiently to ensure complete accuracy and gold-standard follow-up to each encounter.

Other features which are considered as characteristic for the invention are set forth in the appended claims.

Although the invention is illustrated and described herein as embodied in an integrated records system and method, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiments when read in connection with the accompanying drawings.

### BRIEF DESCRIPTION OF THE DRAWINGS

Like reference numerals refer to like items throughout the drawings.

FIG. 1 is a block diagram of a system that can be used in connection with the system and method of the present invention.

FIG. 2 is a flow diagram of one particular embodiment of a method useful with the present invention.

FIGS. 3 and 4 are exemplary graphical user interfaces that may be used to assist in entering new patient data into one particular embodiment of a system of the present invention.

FIG. 5 is an exemplary graphical user interface that may be used to select a data entry relating to a returning patient in one particular embodiment of a system of the present invention.

FIGS. 6-7 are exemplary graphical user interface screens suitable for use in updating patient information in a particular embodiment of a system of the present invention.

FIG. 8 is an exemplary graphical user interface screen suitable for use by office personnel in inputting the information useful for preparing a bill, in accordance with one particular embodiment of the present invention.

FIG. 9 is one possible example of a Progress Note Form generated by the system for use by a particular doctor during the examination of a specific patient, in accordance with one particular embodiment of the present invention t.

FIG. 10 is an example of the Progress Note Form of FIG. 9, as annotated by a doctor.

FIG. 11 is one possible example of a Problems and Medications Form generated by the system of the present invention for use by a particular doctor during the examination of a specific patient.

FIG. 12 is a flow diagram of one particular embodiment of a method of processing patient information useful with the present invention.

### DETAILED DESCRIPTION OF THE PREFERRED EMBODIMENTS

A first preferred embodiment of the present invention will be described in connection with a medical records system and method. However, it will be seen from the description herein that the integrated records system and method of the present invention can be adapted for use in other industries without deviating from the spirit of the present invention. The following are terms used in this description of the system.

Doctor—Although the present embodiments will be described as using a “doctor”, the term shall be understood to include any type of medical professional who can treat, prescribe for and/or counsel the patient, including, but not limited to, a physician, a chiropractor, a nurse practitioner, a medical consultant (internet-based, or otherwise), and/or other medical personnel.

Encounter—This is the occurrence of a doctor examining a patient. The doctor asks questions and examines the patient in an attempt to gather enough information so that, when combined with information gathered by the physical examination and perhaps information provided by diagnostic tests such as lab work and/or imaging studies (such as MRIs and X-Rays) the doctor can make a diagnosis.

Diagnosis or (plural) diagnoses—A doctor's opinion of a patient's condition. Traditionally, making a diagnosis requires a patient encounter. It is a hypothesis the doctor arrives at based on scientific evidence, training and best practices.

ICD 9 codes—An extensive list of numerical codes that are associated with diagnoses. These codes are designed to very specifically describe a patient's condition. The government has stratified these codes into levels of difficulty, assigning values relative to the amount of effort required by the doctor to maintain the patient in good health (when possible). The more difficult or complex it is to care for a patient, the larger the fee that doctor may be paid for a patient encounter.

Standard of care—A uniform set of actions that are expected from the doctor when a specific diagnosis is made. Goals are often set for patients with a specific diagnosis that require certain actions and follow up. For example, in the case of a person with hypertension (the diagnosis made by taking the patient's blood pressure and finding it to be elevated), the standard of care may be a progressive series of treatments that start off conservatively (such as low sodium diet, weight loss, and stress reduction) and ramp up according to the patient's response to treatment (starting with oral antihypertensives and perhaps requiring a patient to receive IV medication in an intensive care unit). Deviating from the standard of care may be considered malpractice.

Progress note—A typically hand written note made by the doctor documenting a patient encounter. Commonly, it takes the form of a SOAP note. SOAP is an acronym for subjective, objective, assessment and plan. “Subjective” is why the patient came to the office that day, otherwise known as the chief complaint. For example, the patient may have come to see the doctor because he has a sore throat. “Objective” is the findings the doctor makes upon examining the patient. For example, the patient's throat may be red and swollen. “Assessment” is the same as the diagnosis. In the above example, it may be pharyngitis or upper respiratory tract infection or strep throat. “Plan” is a term indicating all tactics chosen by the caregiver in order to best manage and/or resolve the medical situation at hand. For example, the “plan” may be salt water gargles, and/or oral antibiotics.

Problem list—a list of a patient's chronic conditions that typically grows with the aging process. It is a list of diagnoses.

Medication list—a list of the medications the patient is currently taking.

Surgical history—a list of the patient's surgeries. The list is associated with dates or ages (hysterectomy, age 35 or bypass surgery, 1991)

Social history—The patient's habits such as smoking, drinking, sexual orientation, drug use, number of children, etc.

Medical record—a file that includes progress notes, lab results, x-ray results, consultation notes (progress notes from other doctors the patient may have seen), a problem list, a medication list, social history and a surgical history. In addition, the medical record contains demographic information, insurance information, contact information, copies of identification documentation, and intra office worksheets.

Medications and Problems Sheet—A special worksheet that is a patient's health care summary. This includes demographic information, allergies, medication list, problem list, surgical history and social history. Most medical records have a similar area where this information is organized.

Encounter Form—A preprinted form that has areas assigned to specific information such as patient information, date/time, vital signs, and SOAP note blanks (or frames). In the case of the invention each encounter form is custom printed with areas for all of the above, as well as a mini problem list (a list of recent, active diagnoses that the doctor can check off if he addresses the problem during the visit).

Superbill—A preprinted form that contains ICD-9 (procedure), encounter billing, and prescription codes for the purpose of accurate checkout, follow-up and billing to the insurance company or other third-party payer.

System—The hardware and/or software used to perform the functions and methods of the invention, as described herein.

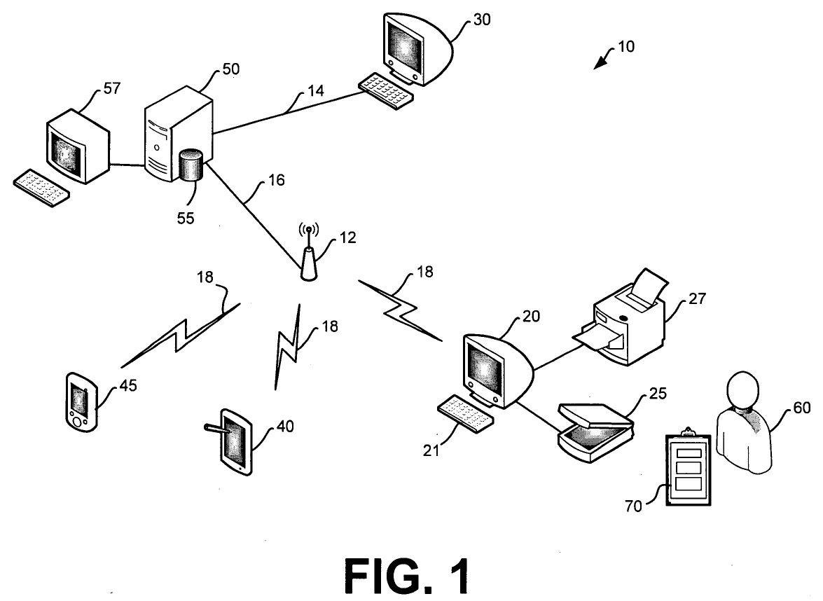

Referring now to FIG. 1, there is shown a system 10 that can be used in connection with a system and method of the preferred embodiments of the instant invention. Such a system 10 includes at least one computer 20 and, preferably, as shown in FIG. 1, a data network, which may be a wide area network (WAN) or a local area network (LAN), as desired. The computer 20, which includes a monitor and at least one input device, is dedicated for use in medical location utilizing the system, for entry of patient data and for creating patient forms and educational materials. The input device for the computer 20 can be, for example, a keyboard 21 and/or scanner 25. Additionally, the computer 20 can be in data communication with a printer 27, either directly or through the computer network. Further, each medical location can include a plurality of local computers 20 and their associated hardware.

Note that the use of a network and/or a plurality of computers and devices, as shown in FIG. 1, is not meant to be limiting, as the system 10 of the present invention can be encompassed on a single computer, if desired. As additionally will be discussed, several computers 20, 30 and/or other types of devices 40, 45 can be networked to a central database server 50, wherein patient records are stored in a database 55. Alternately, or in addition thereto, patient records can be stored in a memory device at the local computer 20. Additionally, the system 10 includes software that processes patient information to populate the database 55 with patient specific information and, if desired, to generate patient specific forms, records and documents. The software can run locally, for example, on the local computer 20, or can be run remotely (i.e., on the server 50 or computer 30) and accessed by the local computer 20, via the network. Additionally, part of the software can be run locally and part remotely, if desired. For example, task specific software modules can be stored on, and executed by, the local devices 20, 40 or 45, wherein the results obtained by those modules can be provided to software running on a device remote from the devices 20, 40 and/or 45. In one particular embodiment, the system 10 has a “client-server” architecture. In this particular embodiment, the client can be invoked from a remote location, but it must “run” on the machine attached to the scanner.

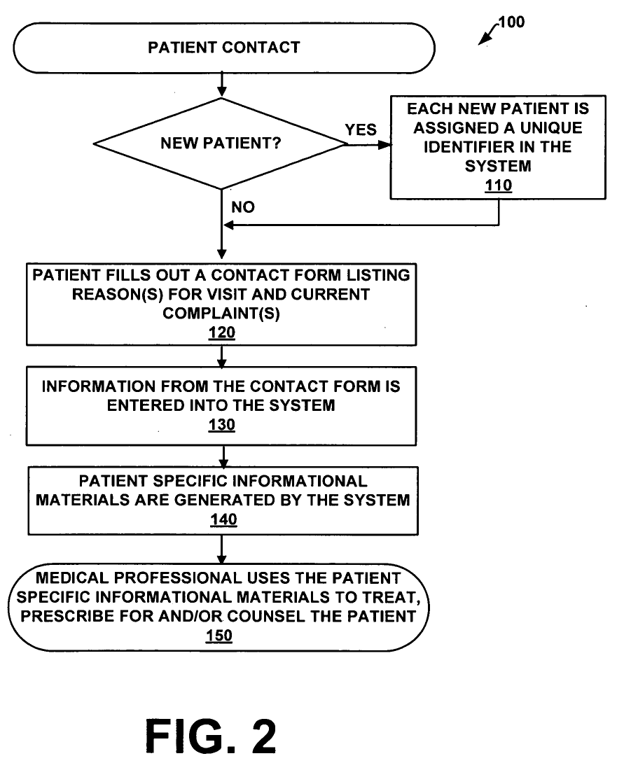

The use of a system, such as system 10, running software for performing a method 100 in accordance with one particular embodiment of the present invention, will now be described in connection with FIGS. 1 and 2.

### Check-In:

When contact is made with a patient 60 in a medical setting for the first time (i.e., doctor's office, emergency room, pre-registration for a visit or procedure, etc.), reception will assign him or her a patient identifier that is unique to that patient 60. Step 110. This unique patient identifier represents the patient 60 in the system 10, for example, becoming the patient's chart code. Typically, at the beginning of each contact with a patient 60, he or she is asked to fill out paperwork 70 (i.e., a “contact form”) describing the reason(s) for the visit, including a description of any present complaint(s) of the patient 60. Step 120.

The information provided by the patient 60 on the contact form 70 is entered into, and stored in, the system 10 of the present invention, either locally (i.e., in computer 20) or remotely (i.e., in server 50). Step 130. For example, the information from the contact form can be stored in a system database 55, via the local computer 20.

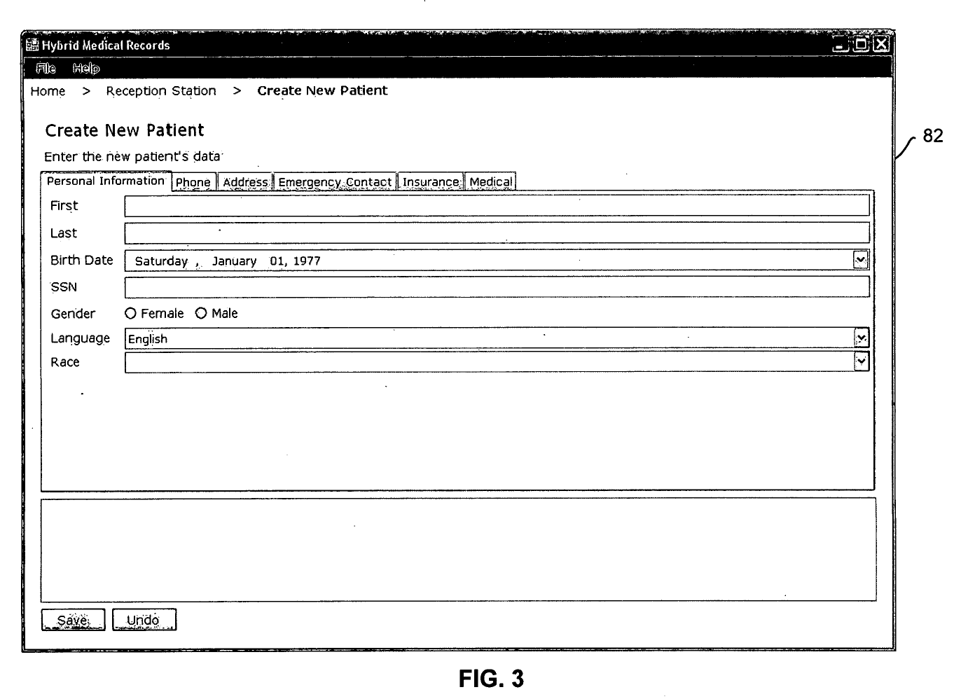

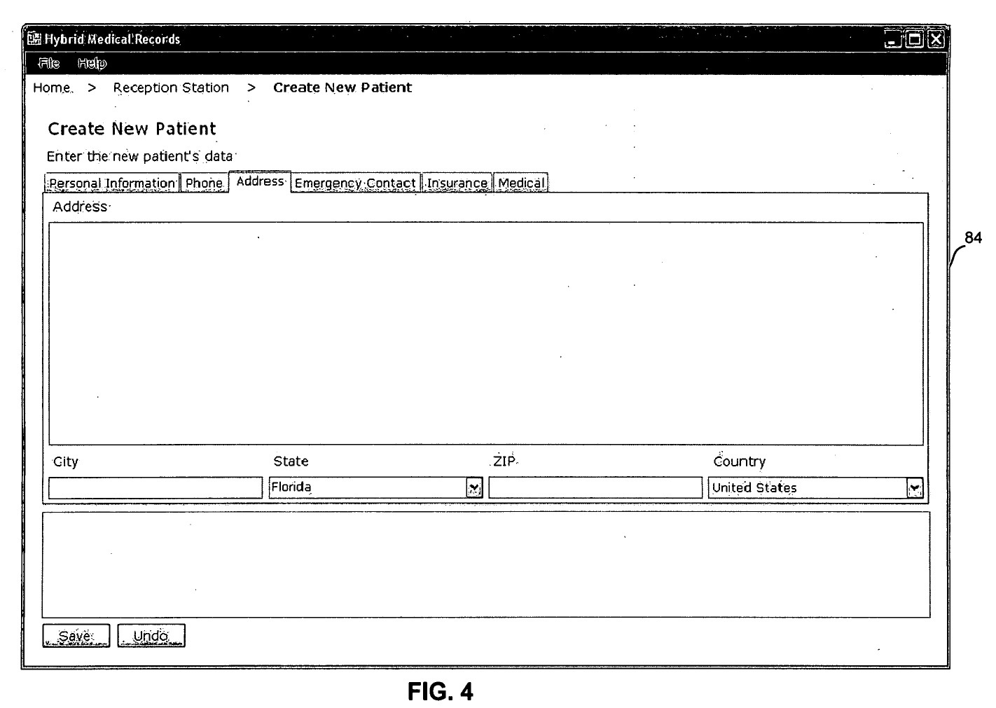

In one particular embodiment of the present invention, the information about the patient 60 contained on the contact form 70 is entered into the system in conjunction with prompts provided by the software executed on the system. For example, referring now to FIGS. 1-4, in the case of a new patient, the information from the contact form can be entered into the system using a graphical user interface generated by the execution of the system software. FIGS. 3 and 4 show examples of such graphical user interfaces that may be generated for use in creating a new patient data record. More particularly, the screens 82 and 84 of FIGS. 3 and 4, respectively, can be used to enter information about a new patient, such as, for example: name, address, employer, date of birth, social security number, home phone number, primary insurance carrier name and number, secondary insurance carrier name and number, primary or assigned physician, emergency medical contact, etc. This information, once entered, forms a data record associated with the unique patient identifier of this particular new patient, which becomes part of the patient's electronic chart. Note that, the in the present embodiment, the information from the contact form 70 can be entered into the system via the local computer 20, using the keyboard 21 and/or the optical scanner 25, as will be discussed more particularly herebelow.

Typically, a new patient will also fill out a “history form”, describing the new patient's past medical history. If desired, the system software of the instant invention can be programmed to, both, store an image copy of the optically scanned form in the patient's record, and convert the optically scanned version of the patient's history form into textual data stored in an additional data record associated with the patient's electronic chart. Alternately, the information on the history form can be entered into the system manually, via the keyboard 27.

The provision of the scanner 25 at the local computer 20 is also useful for recording and storing a digital image of the patient's insurance card and photo identification into the patient's electronic chart, if desired. The office personnel can use the stored patient photo identification each time the patient visits, to verify the identity of the patient and prevent another person from using that patient's insurance card or information.

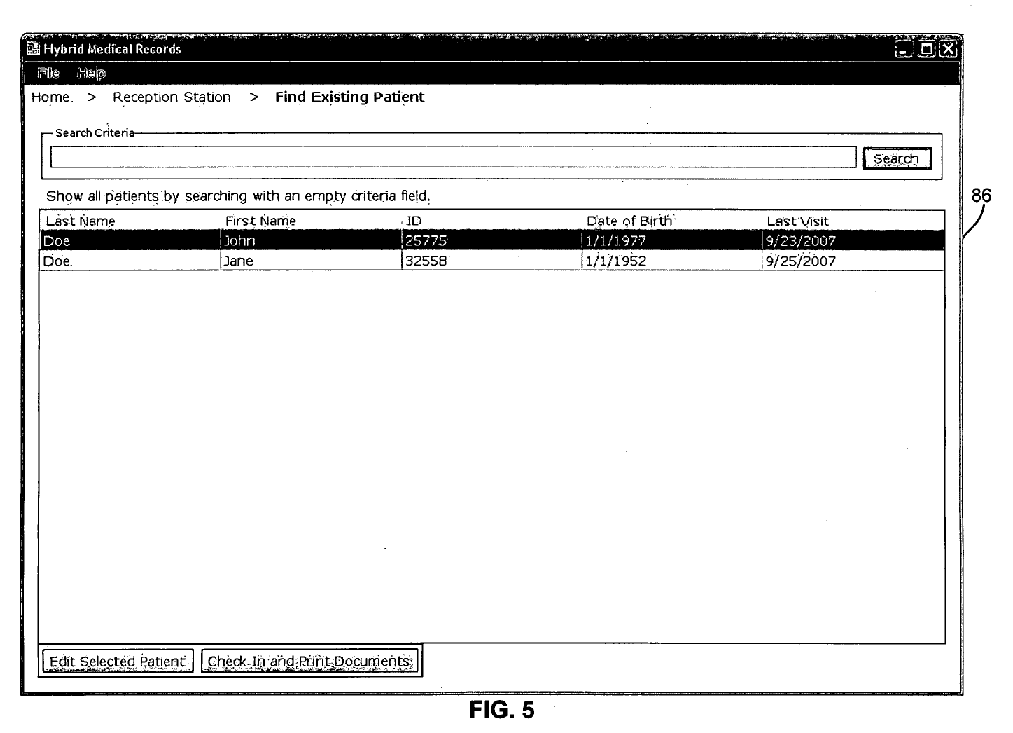

If the patient is not a new patient, but a returning patient already associated with a unique identifier, the contact form information for the current visit is entered into the system, via a local computer 20 and/or its associated peripherals 25, 27. For example, the software can prompt the entry of a returning patient's contact form information after the returning patient has been identified in the system using, for example, the graphical user interface screen 86 of FIG. 5. In addition to the name of the patient being displayed, as shown in FIG. 5, if desired, a thumbnail version of the photograph from the patient's photo identification can be included (if available). Inclusion of the photograph helps the office personnel to match a files to the correct patient, especially when multiple patient's of a particular office have the same or similar names.

Using the graphical user interface of the software of the present system, office personnel can edit and update the information of an existing patient. The edited/updated patient records can be stored as new data records in the patient's electronic chart, and associated with the date the edits were made, rather than replacing the previously entered information in the electronic chart.

After the new and/or returning patient's contact form and/or history form have been entered, this information can be used to generate a Progress Note, Problems and Medications Sheet, Superbill and/or other materials used by the doctor in treating, prescribing for and/or counseling this particular patient. In one particular embodiment of the present invention, the materials prepared in connection with a particular patient are printed out, for example, on a printer 27, and placed in a folder for the doctor. Alternately, such materials can be provided to an electronic device consulted by the doctor during the examination, for example, a personal data assistant (PDA) 45, a tablet pc 40 and/or a local computer 20.

When a paper file or chart also exists for a patient, a duplicate of the chart can be maintained electronically in the system. If desired, the paper charts can include appropriate barcoding, such that the scanning of the barcode into the system can automatically cause the system to locate and pull up the patient's electronic chart in the edit mode of operation. This will more easily facilitate the editing and updating of the patient's electronic and paper charts. Barcoding of the paper chart also provides other conveniences, including helping with file location and inventory.

During the patient encounter, the doctor can review the forms generated for that particular patient and manually update them, as necessary. The doctor may also choose to update the patient specific forms in the privacy of his or her office during or after the visit. Such updates can include check marks and/or handwritten notes of the doctor written on the prepared forms (i.e., with a pen or pencil on a paper form or a stylus for a form provided on a PDA or Tablet PC). The updated forms (i.e., including the doctor's notations) can then be entered into the patient's electronic chart in the system. For example, the doctor and/or his staff can take the updated, paper Progress Note and M&P Sheet and scan them into the local computer 20, via the scanner 25. Alternately, the Progress Note and M&P sheet can be provided to a contractor or service, to be scanned and/or entered into the system, remotely. Of course, electronically updated forms need not be scanned, but will be processed in a manner similar to the scanned forms, as will be discussed below.

In addition to notating the patient encounter form, the doctor can mark the pre-printed Superbill to indicate the length of visit, all procedures performed, and a time period for follow-up. Necessary lab work, x-rays, follow up frequency, and medications indicated on, or derived by the system from, the encounter form are routed by the system 10 to the appropriate stations 20, 30, etc. These stations are created at installation by permissions, which designate the types of information each user may access.

The scanning/processing of each patient's updated documents triggers a series of actions, including:
1. If a patient meets the criteria established by the Medical Director of that particular office, an alarm is initiated to ensure follow-up for designated tests and/or procedures;
2. Changes in complaints, conditions, or medications establish a task in the doctor's screen to ensure timely updating of the patient's electronic chart at the end of the day; and
3. Patient education for specific complaints and conditions is generated by the system to be given to the patient at checkout. The bank of possible educational documents can be created in the system by the Medical Director of the office to comply with best practices.

For each of the patient's subsequent visits, the software of the system of the present invention creates, in a computer automated fashion, a new, unique set of patient specific documents based on the updated information input from the patient's previous and present visits. Additionally, the system can obtain, and/or personnel in the office can check for, the results of any prescribed tests and lab work, which results can be integrated into the patient's electronic chart. In this way, the results of follow-up procedures conducted outside the office can become part of the patient's electronic chart. As such, these results can be noted and indicated on the Progress Note provided to the doctor at the patient's next visit.

### Visit Management:

In one particular embodiment of the present invention, prior to the actual patient-physician encounter, the system of the invention automatically generates a 6-digit appointment code when a patient calls for an appointment based on the time they called, whether or not it is an emergency, and the acute nature of their disease(s) and/or symptom(s). The system can be programmed to prioritize patient examination order at the office based on similar criteria (advance call, acute nature of disease, time of office check-in, etc.). Resultantly, the system can display the order to be seen and “call” the patients when their exam room is ready. Additionally, in this embodiment, the system can include programming to manage the local waiting room by assigning a value to a patient based on parameters such as the individual patient's on-time record for recent visits, previous waiting times, and acuity based on their medical record. For example a patient with a serious lung condition may not have enough oxygen in their portable tank to wait more than 30 minutes before being called. Patient's acuity can be manually set to “call in immediately”, “quick consult”, “routine”, or “chronic”. The system can also be programmed to manage patient flow by noting the frequency of patient call-ins by doctor.

For example, using one particular embodiment of the present invention, if Doctor X sees (i.e., has their patient's called in) twice as fast as Doctor Y, then the system may fill an empty exam room with a Doctor X patient before a Doctor Y patient, if it notes that multiple Doctor X patient's have recently checked out. This is to prevent Doctor X from having down-time because all the rooms are filled with the patients of the slower Doctor Y. Additionally, in one particular embodiment, the system's integration with the patient schedule database may additionally note that most of the faster Doctor X's patients have already been seen and, resultantly, assign more rooms to Doctor Y. Also, if Doctor Y's patients have been waiting too long, the system will give them preference. Moving from the waiting room to an exam room is perceived by patients as progress and helps maintain a positive experience for the patient.

The parameters or rules that guide the above-described operation of the system can be programmed into a patient flow software module that is set up by the office manager and running locally on the computer 20 or, if desired, remotely on the server 50. Wait time statistics per doctor are viewable in a spreadsheet format to help guide programming this function. This spreadsheet also allows for feedback to the physician to help motivate better performance.

### Patient Specific Form Generation:

The documents created by a system 10 in accordance with one particularly preferred embodiment can include, but are not limited to:
1) The Progress Note, which is modeled after the look and feel of a standard Progress Note. This minimizes the technological input at the examination encounter, and decreases the learning curve. It has an area where the physician can bubble next to diagnoses that are chronic in nature so that repetitive actions and thought processes appropriate to the diagnoses can be documented by inputting them into the computer via scanner. There are also areas for hand-written notes relative to the patient's history, any abnormal observations by the physician, the physician's assessment and plan. These pieces of information are distributed to appropriate stations for processing, as well as placed in a queue for chart revision by the physician. The resulting electronic medical record is rich in content. The paper chart contains the salient points from a visit and can further provide verifiable documentation of the history of the patient and his treatment, as it is both physical and provably authentic.
2) The Medications and Problems Sheet, which is a summary of the patients' medical conditions/diagnoses and current treatments. It contains multiple lists such as problems, allergies, surgeries, medications, and recent labs/diagnostic studies performed. The Medications and Problems Sheet, like the Progress Note form, can include areas for handwritten notes, as well as areas including check boxes and/or “bubbles” intended to be checked or “marked-out” by the doctor. The Medications and Problems Sheet, and correspondingly, the database used by the system to create it, will need to be constantly updated to reflect new conditions, medications, surgeries, and tests the patient may experience while under the doctor's care. The present form is a thorough and timely reminder to the practitioner of a specific patient's condition and any treatments or procedures that need to occur to ensure gold-standard care.
3) The Superbill is a summary of the care the patient received on any given day. It is the doctor's bill. It contains all the information needed to bill an insurance company or any other payer. It is also a useful tool to help provide feedback data into the system. It can be used to populate the problem/diagnosis list. It also assists personnel to do their jobs by documenting how much the patient owes (co-pay), the relative intensity of the visit, when the patient needs to come back, and the patient's needs (i.e., specialist referrals, X-rays). It can be stored separately from the paper chart, for example, with the Superbills of other patients seen that day. This, in essence, creates triple information redundancy, as the essential information about a patient's visit is stored in the paper chart, the electronic medical record, and the Superbill (the summary).

It should be noted all three documents contain some of the same information. Each document needs patient demographical information. This is name, sex, date of birth, smoker (?), social security number, insurance company (or cash), insurance ID number, and medical record number.

### A. The Progress Note:

The customized Progress Note, including the patient's chronic diagnosis, is printed in a manner that allows the physician to “check-off” the patient's chronic diagnosis, as he discusses each chronic diagnosis with the patient and while he examines the organ system involved. The normal (routine) physical exam that the physician normally performs is also printed by the system on the Progress Note, so the physician can check off the normal findings as they are examined. If the physician examines an organ system and finds it to be abnormal, the physician can indicate this by checking the “abnormal” box on the Progress Note. As will be discussed further below, the system 10 is programmed to look for a written description of the abnormal finding in a dedicated field of the Progress Note form, devoted to hand-written abnormal findings. The Progress Note, as customized for each patient, can also include the patient's demographics and can be tailored to the general category into which the patient falls. For example, the Progress Note for a female patient will not provide, for example, a box to check next to “prostate exam”.

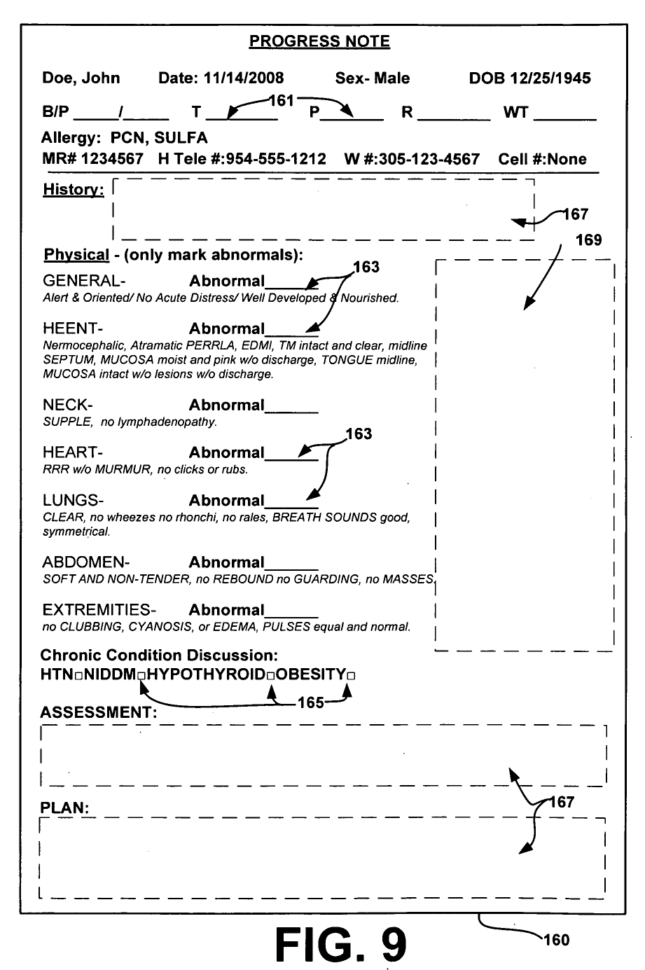

Referring now to FIGS. 1 and 9-10, the preparation of a patient specific Progress Note 160, in accordance with one particular embodiment of the present invention, will be described. The system of the invention is programmed to create a custom Progress Note 160 for each patient, based on information entered into that patient's electronic chart. For example, as shown in FIG. 9, the computer generated Progress Note 160 includes information of a patient obtained from the patient's most recent contact form, as well as the previously stored and updated electronic patient chart. In the particular example shown in FIG. 9, the software utilizes information stored in the system as recently as the present check-in, to provide the patient's name, gender (SEX), date of birth (DOB), allergies (Allergy), unique patient identifier (MR#) and various telephone numbers (H Tele #), (W #), (Cell #). Note that this is not meant to be limiting, as more or less information from the patient's records can be provided on the Progress Note 160, if desired.

Additionally, the Progress Note 160 of FIG. 9 includes pre-drawn blanks 161 for recording the vitals of the patient obtained during the current visit. The pre-drawn blanks provided on the Progress Note 160 can be tailored to each, individual doctor's particular practice. This can be done by customizing the Progress Note template in the system 160 to recite a checklist of queries typically asked as part of a particular doctor's examination routine. For example, the form 160 includes areas 161 for recording the patient's current blood pressure (B/P), temperature (T), pulse (P), respiratory rate (R) and weight (WT).

The system can additionally be programmed to further tailor the Progress Note 160 based on the stored data relating to the patient's current chronic conditions and on the organ systems necessary to evaluate those conditions. Notes and reminders that permit the gathering of information on standard organ systems can also be included on the customized Progress Note 160. For example, the system 10 is programmed to interpret notations made on the Progress Note 160 to determine the condition of each of the physical systems (GENERAL, HEENT, NECK, HEART, LUNGS, ABDOMEN, EXTREMITIES) based on the doctor marking blanks 163 associated with abnormal organ system with a check mark 190 on the Progress Note 160′.

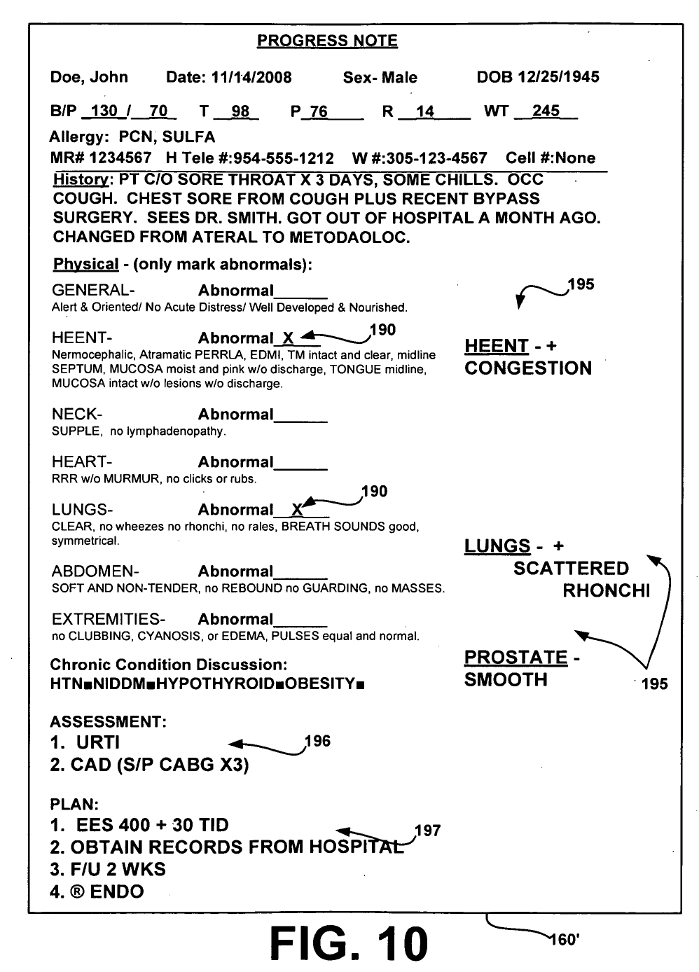

Additionally, the Progress Note 160 reserves dedicated areas of the form 167, 169 (shown in dotted line) in which the doctor can make handwritten notes (195, 196, 197 of FIG. 10). As will be described more particularly below, the system 10 of the present embodiment is programmed to capture the handwritten notes 195, 196, 197 of the medical attendant and/or doctor, made in the dedicated handwriting fields 167, 169, and to, resultantly, store images of the handwritten notes in the patient's medical records, as well as, determine the meaning of the handwriting (i.e., OCR) and generate educational materials related to each chronic condition on the “patient encounter summary”, schedule follow-up appointments, tests, and procedures.

The Progress Note form 160, 160′ can additionally include bubbles 165, that can be marked out once the doctor has discussed a certain topic with the patient.

It is important to note that the Progress Note, as well as the forms mentioned below, are dynamic and change with each change entered during a patient encounter. The change will be reflected on the subsequently generated Progress Note to be printed for the patient's next appointment with the office.

Although a particular exemplary Progress Note 160 is shown, this is not meant to be limiting, as it is understood that this form, and any other form provided in connection with the present invention, can include any desired number of write-in blanks 161, check boxes/blanks 163, mark-in bubbles 165, and “dedicated handwriting fields” 167, 169.

### B. The Medications and Problems Sheet:

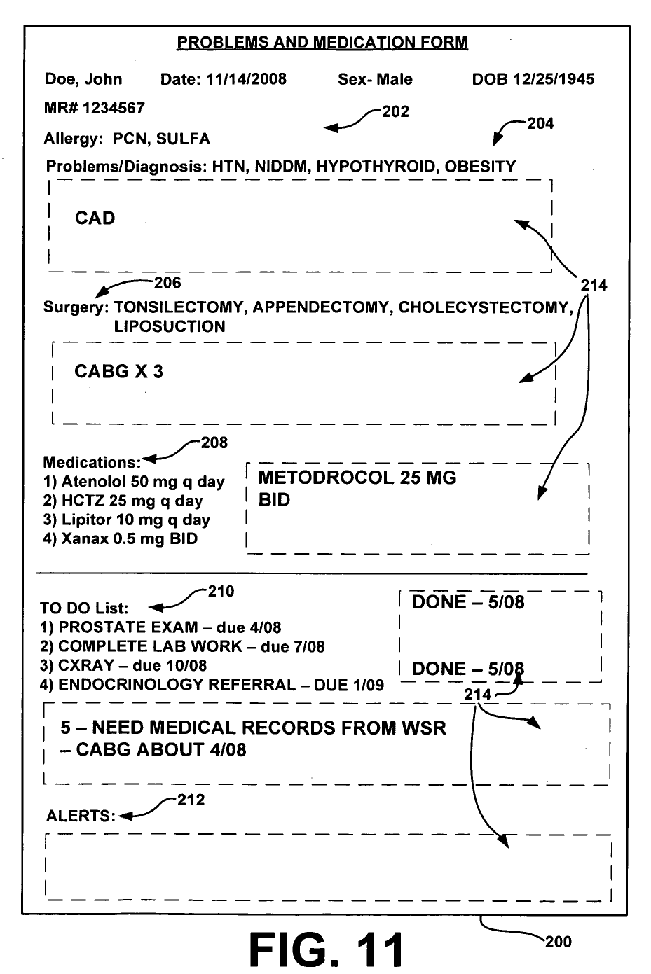

The system 10 can additionally be programmed to generate a patient-specific information worksheet known as a “Problems and Medications” form, one example of which is shown in FIG. 11. The Problems and Medications form, like the Progress Note, is generated by the system through the extraction of certain information from the patient's electronic chart. In the present preferred embodiment of the invention, the “Problems and Medications” form 200 generated by the system will include, but not be limited to, the following; 1) name, DOB, and other demographics 202; 2) list of chronic conditions 204; 3) medication list 208, 4) past surgical history 206, 5) TO DO list 210, and 6) ALERTS 212. The TO DO list includes, among other things, any test, procedure, lab work or other necessary and as yet undone task for this unique patient, and the ALERT shows any urgent information, such as a missing report from an ordered x-ray or other outside information.

As with the Progress Notes form 160, the Problems and Medications Form 200 includes dedicated areas 214, in which the doctor can make handwritten notes for extraction and storage by the system.

### C. The Superbill:

If desired, the system can also be programmed to create a billing sheet called a SUPERBILL that allows the physician to check off the diagnosis of the patient and gives an approximate amount of time that the physician spent interviewing and examining the patient.

The Superbill, like the Progress Note 160 and the Problems and Medications form 200, can include check boxes and dedicated fields for handwritten notes of the doctor. Correspondingly, when scanned into the system 10, the system can extract information related to the patient visit based on which boxes are checked. Additionally, any handwritten notes in the dedicated fields can be stored in the patient's electronic chart as image data, as well as OCR recognized text data.

Thus, in one preferred embodiment of the present invention, the system is programmed to create at least three documents that are applied to the patient's chart before the doctor sees the patient. These documents are designed to help guide the physician through the customized examination of this particular patient and provide the physician with information to improve his or her awareness of the patient's medical condition to date, and outlines the tasks needed to be performed in the immediate future without being intrusive to the doctor-patient encounter.

In the present preferred embodiment, the documents that the system creates are designed so that a doctor could, upon glancing at them, be immediately aware of 1) the patient's chronic conditions, 2) the things he needs to do today, and 3) the thing he wanted the patient to do but was not done or reported (in this case the chest x-ray). The doctor then may then have a discussion with the patient about why she is here today (called the chief complaint) and record the information in the blank space marked “chief complaint”, discuss the patient's chronic conditions (such as hypertension “So you are avoiding salt and taking your medicine? You check your blood pressure at home?”), and mark the boxes next to the chronic complaints he has discussed that day. He may examine the patient and find everything normal except the patient has some nasal congestion. So he would check the “normal” box next to all the organ systems except HEENT (head, eyes, ears, nose and throat) he may check ABNORMAL, and write in the blank space marked “abnormal physical findings” the following “nasal congestion. No swelling or redness pharynx”.

In practice, prior to examining each patient, the system generates a Superbill, a Progress Note, and a Medications and Problems Sheet, customized to this particular patient. The forms generated by the system are printed and are applied to the patient's paper chart. The patient is brought back to the room, where the doctor interviews and examines the patient, documenting the results of this encounter by making marks on the three (3) documents. The patient then leaves the exam room and is ‘checked out’.

If desired, the actual forms marked by the doctor can be retained in the file. Such documents serve a number of purposes. For example, such paper documents can be retained for use in a subsequent litigation and/or dispute, wherein the caregiver's original markings may be scientifically analyzed to determine the exact age of the ink, in order to verify the date and veracity of the information stored in the system, via scanning.

### Check-Out:

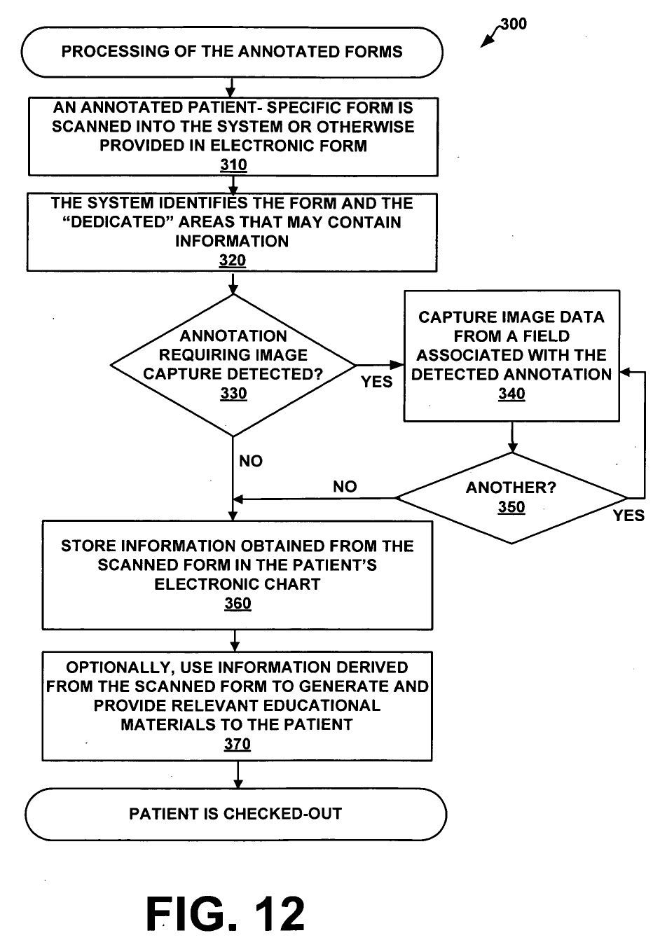

Referring now to FIGS. 1 and 9-12, there will be described a method 300 of processing the annotated forms in accordance with one particular embodiment of the present invention. For purposes of explanation only, it will be assumed that the method 300 is being used to process only an annotated patient-specific Progress Note 160′, Problems and Medications Form 200 and a Superbill. However, it is to be understood that this example is not meant to be limiting, as more or fewer types of annotated forms can be processed by the system 10 in any given patient visit.

Once the patient leaves the exam room, the patient-specific forms, annotated during the examination, are used to “check-out” the patient. More particularly, at check out, the paper documents that were annotated by the doctor and/or staff (160′, 200) are scanned at the scanner 27 to convert the annotated patient-specific documents into image files to be stored in, and processed by, the system 10. Step 310 Any dictation may also be associated with the patient visit at this time, or at the end of the day.

In an alternate embodiment of the present invention, mentioned briefly above, the doctor creates the “annotated” forms electronically, for example, by handwriting notes in dedicated note fields of an electronic form displayed on the touch screen of a PDA 45 or tablet PC 40, using a stylus. Such electronic “annotated” forms will be provided to the system as “integrated document” image files equivalent to those of the scanned paper forms (Step 310), and thus, can be subsequently processed in the same or similar manner. Note however, that in a system in which the doctor creates electronic “annotated forms”, such forms would most preferably also be printed out and stored, in paper form, in the paper copy of the patient's chart, for redundancy and completeness.

A copy of the image file of the entire scanned document is saved in the file, for reference. Additionally, the system 10 processes the image file, to extract the doctor's annotations. To do this, the system 10 first determines the type of form (i.e., “recognizes” the form) and breaks down into its component parts. Step 320. For example, the system 10 is programmed to dissect the form into various “regions”. The system 10 can additionally be programmed to compare the image of a known region of the scanned form, say the title area (i.e., “Progress Note”) to pre-stored sample images, in order to identify the form type and assist in the extraction of relevant information. In doing so, the system identifies any changes the doctor has made to or on the original form, printed earlier, so that the system can use this information to update the patient records and/or take other appropriate actions. Alternately, if desired, the printed form can include a particular code or symbol (like a bar code) in a preset location on each of the forms, to permit the system 10 to identify the form type. As a further alternative, a user can manually identify the type of form to the system at the time the form is scanned.

Once the form is identified, the system 10 uses previously stored criteria about the form to determine which “fields” or regions of the form should be checked for annotations. Note that, because the forms are generated to be “patient-specific”, the fields to be checked may also be patient-specific, or more particularly, specific to the particular form generated for a particular patient. For example, the system 10 generated the particular patient-specific Progress Note 160 to include seven physical systems, each including a check blank 163 for notating an abnormal condition. Another Progress Note generated by the system 10 for a different patient may include more or fewer physical systems, and correspondingly, more or fewer check blanks 163 to be interpreted. Thus, the system 10, having generated the form for a particular patient, is thus pre-informed on which regarding the regions of the form to be examined for notations.

Using the form 160′ for exemplary purposes only, if the system determines that the scanned image is a “Progress Note” and is associated to a particular patient (i.e., unique MR#), then the system 10 knows which dedicated fields to examine for writing. Step 320. For example, the system 10 having created the write-in blanks 161, knows to extract written information from them. The system 10 can additionally be pre-informed regarding what to do with writing detected in a particular dedicated field. In the present example, an image of each write-in blank 161 is captured and converted by the system 10 into text using OCR techniques, and the converted information is stored in the patient record. Steps 330-340.

However, information obtained from other parts of the form can be treated differently. For example, the system 10 knows to check whether the bubbles 165 are marked out on the Progress Note 160′. The system may use this information to make a note in the file that the doctor discussed certain topics with the patient (as indicated by a marked out bubble 165), but did not discuss other topics (as indicated by an open bubble 165). The system 10 can then use this information to generate further educational materials for the patient and/or to remind the doctor to discuss an unmarked topic with the patient at a later visit.

Additionally, the system may be programmed to only check certain dedicated fields, if another dedicated field is determined to have writing. For example, in one particular embodiment, an image of the dedicated note field 169 of form 160′ is only captured if a corresponding check blank 163 is determined to have been checked. Steps 330-340. For example, if none of the blanks 163 are checked, thus indicating that all of the patient's physical systems were found to be normal, the system does not need to capture or process the dedicated note field 169, which should be blank. However, a determination by the system 10 that one or more check blanks 163 were marked by the doctor would trigger an image capture of either the portions of data field 169 associated with the marked system, or the entire data field 169.

Additionally, certain fields on the form 160, 160′ are dedicated handwriting note fields which require no precondition for image capture. For example, if desired, the system can capture and store image data from the fields 167, without requiring anything else to be checked. Alternately, the system 10 can use image processing techniques to determine which fields 167 contain writing and then store image data from only those fields. Steps 330-340.

As such, the system (i.e., software) of the present invention is programmed to break each document down into its component parts. The system analyzes the check marks (190 of FIG. 10) on the page and records and/or otherwise processes the information conveyed by the check mark (or lack of check mark). The system can use a look-up function to associate the information conveyed by each check mark with a canned statement of what that information means, in the Doctor's own verbiage. For example, if the “abnormal” blank on the form next to the is not checked, then the text block “clear to auscultation. No rales or rhonchi. Good breath sounds”, programmed into the system by the physician at setup, is associated with the patient's data file for this date. The text block is created during program installation to insure that the output of the system matches the individual practice style of the physician.

If the blank or box marked “abnormal” is marked next to the lung exam, then no text block will be automatically associated with the lung exam. Instead, detection of the check mark in the “abnormal blank or box” causes the system to capture a digital image of the handwritten field (195 of Progress Note 160′) and stores a digital image of the handwritten field in the data record, using appropriate image compression and/or processing formats (i.e., JPEG, TIFF, BMP, PDF, etc). This process is repeated for all physical exam systems. Steps 340-350. Additionally, the system determines whether or not there are handwritten notes in the other dedicated handwriting fields (169 of FIG. 9) and, if so, captures digital images of those fields for storage with the data record. Steps 340-360.

All three documents, described above, are similarly broken down into their various handwritten fields and check box fields. The system then takes all the fragments of the original documents and redistributes them according to user preference.

For example, the system may have multiple users. The billing employee user prefers to see only the handwritten diagnosis field from the progress note, the data gathered by the system from the “Physical” check box field from the Progress Note, the handwritten diagnosis field from the Superbill, the data gathered from the checkbox field of the Superbill, and the patient's problem list which is a list associated with each patient and prominently displayed on the MEDICATIONS AND PROBLEMS SHEET. The lab technician user may set preferences to only display the “plan” handwritten field 197 from the Progress Note 160′, the diagnosis handwritten field from the Superbill and the information gathered from the “procedure” checkbox field from the Superbill.

The system thus stores and redistributes medical information dynamically, according to the needs of each unique patient encounter, to allow instant access to the information each member of the medical office team needs to perform their job. The information in the dedicated handwriting fields of the various documents can be extracted and stored as textual data in the system 10, either by keyed entry by office personnel, and/or by OCR performed by the software of the system 10.

The system 10 can additionally be programmed to utilize the data obtained from the processed, annotated forms to perform particular functions and/or set reminders. For example, the system 10 can be programmed to use the information derived from the scanned forms to generate educational materials that are specific to each patient's needs, which materials can be provided to the patient at check-out. Step 370. In such a system 10, a bank of educational materials on a range of foreseeable topics can be stored in the database 55 of the system 10. These materials can be general materials and/or materials designed, approved, and/or customized by the doctor and/or medical director of each office to ensure a thorough flow of information and best patient home care practices. These educational materials can be further customized for every disease state encountered in a particular doctor's practice, using the particular words of the end-user doctor, and reflecting his own unique best practices of consultation and treatment. Then, based on the notes recorded by the doctor on the Progress Note during the patient examination, the system 10 cherry picks the relevant educational materials for this patient from the database of educational materials stored in the database 155.

### Additional Data Entry:

The information from the scanned patient forms can be also be used at other “stations” (i.e., computers 20, 30 of FIG. 1) throughout the system 10.

### A. Doctor's Station:

A “Doctor's Station” can be provided wherein the doctor can review and edit the patient's electronic data record. For example, the doctor may make further changes to the encounter form, such as edits to the medication list or diagnosis related clinical action descriptions. Additionally, when image data captured from a dedicated field of a form is converted to text, for example, using OCR techniques, the Doctor's Station can be accessed to make a visual confirmation of the accuracy of the OCR translation.

Further, dictation can be made by the doctor at this station and attached to the electronic patient record. Depending on the needs of the office, the Doctor's Station may be provided with the rights to edit all fields of the patient's data record, or less than all fields.

### B. Nurse's Station:

The system can additionally, include a “Nurse's Station” which is similar to the “Doctor's Station”, but with more limited ability to enter and/or change data in the patient's electronic chart. In one particular embodiment, accessing the data records through a “Nurse's Station” could permit the user only to edit the patient's medication list, but not the diagnosis or other fields.

### C. Billing Station:

The system can additionally, include a “Billing Station” for use by billing personnel in generating bills and billing patients and insurance companies. As with the other stations, the Billing Station can be provided with rights to change all or only certain data fields of the patient's electronic chart.

### D. Administrative Station:

The Administration station is used to manage user accounts (create, modify, delete) as well as set the basic parameters for the office (the name, street, address, and form headings that identify the company to which the documents belong). It can change users' data as well as reset their passwords. The administrative station will also allow the user to perform and schedule backups. It should be considered the highest security station in the system as it allows access to all other stations. It is also the station from which all medical management data (patient education, standard referral requests, etc.) are generated.

Please note that, although the above-described stations are described are discussed as “separate” stations, this can actually be a virtual distinction. For example, it is possible that all of the above-types of stations are identical in software and hardware, but differ only in the rights associated to with the entry of certain passwords. Similarly, all of the “stations” can be embodied on a single password protected local computer 20, wherein different users have different levels of rights to edit the data records. Alternately, dedicated “stations” of the different types can be provided, if desired.

### Automated System Usage of the Annotated Forms:

The system 10 can be programmed to record any requests for lab work, exams, or procedures to be done outside the office made on the form 160′, and to generate reminders to the staff regarding the requests. If, for example, a chest x-ray was ordered by the doctor (as notated on the form 160′) but the staff has not seen a report from the radiologist, the system could be programmed to generate a note to that effect on the patient's file, or to provide some form of alarm at a designated follow-up time to the system user. The appropriate personnel could then call the specialist and correct the problem, or check a box in the system indicating that the report was unavailable, thereby resetting the alarm for a later time. Upon receipt of the report, the appropriate personnel can update the status of the requests, and enter the resultant data into the system, via a peripheral 25, 27 of the local computer 20.

Additionally, the system 10 can be provided/preprogrammed with a set of rules to note the condition of the patient. For example, if the patient has not had a pap smear in over a year, and is of appropriate age and not disqualified by having had a hysterectomy, the rules programmed into the system are used by the system to determine that the patient is in the “needs a pap smear” condition. The system then would add “pelvic exam” to the list of possible organ system examinations, when generating that patient's next customized Progress Note form. When receiving such a form, the physician has the choice of checking the NORMAL, ABNORMAL, or DEFERRED boxes, on that Progress Note.

The system additionally permits the individual physicians using the system to set up the unique meaning of “NORMAL”, and also allows the physician to handwrite the unique abnormal state of the patient in a designated area devoted to this check box on the customized Progress Note. Subsequently, the system can print out on the “patient encounter summary” report the doctor's unique pre-programmed verbiage to describe the patient's exam. The repetitive writing of normal exam verbiage is the physician's standard description of a particular normal organ system. For example “normal pelvic exam” may mean, for a particular physician, “cervix without inflammation, normal color, without discharge, bimanual without evidence of mass. No tenderness noted.” The physician would have entered this “pre-programmed” exam language, and others, into the system, for example, during the system setup phase (i.e., at the time the system program was installed).

Alternately, in setting up the system, the physician can be given the opportunity to use a physical exam description provided with the program authored by an authority, for example, by the head of the OB/GYN department at Tulane University, if the physician agreed with its description of a normal pelvic exam. The setup phase of pre-programming the physicians designated language for each check box condition of an organ system can take less that 15 minutes for a new user physician, if that physician opts for standardized descriptions provided by the program. An online tutorial program can be used to walk the physician thru this customization phase to allow the program to synchronize with the physician's unique practice habits.

Additionally, if desired, the system 10 can be programmed to flag a particular patient's next Progress Note, if there are any discrepancies between the tests, consultations, and procedures ordered at previous visits and the test results, consultation reports and procedure reports entered into the database. For example, there may be a discrepancy between the patient's “event list” that a chest x-ray was ordered but no chest x-ray report has been scanned into the system. The receptionist is alerted to this by “NO CHEST X-RAY REPORT” or “NO CXRAY REPORT” flashing next to the patient's name. If the receptionist cannot obtain the report immediately for any reason, she clicks “not available”. In this case the system will print out “NO CXRAY REPORT ORDERED xx/xx” on the patient information worksheet, known as the MEDICATIONS AND PROBLEMS SHEET.

Further, if desired, the system 10 can be programmed to compare each patient's medical profile (age, sex, chronic diagnosis, medications) against the MEDICAL OFFICE STANDARDS file, to capture deficiencies. For example, Patient X is fifty years old and the last logged mammogram report is more than a year old. The system can be programmed, using rules and/or look-up tables, to add “ORDER MAMMO” to the TO DO list on the Medications and Problems Sheet. In another example, Patient X takes a diuretic, such as is known under the brand name LASIX, and, per the medical office's standards of practice protocol, patients on diuretics require a potassium level to be recorded every 4 months. Patient X has had no labs for 5 months, so the system automatically, per its pre-programmed rules, adds “DRAW SMA7” to the TO DO list.

The system 10 can be further integrated into a doctor's practice to store additional kinds of records in connection with a particular patient's electronic chart. For example, if desired, so as to save, the system 10 can be programmed to save dictation as an attachment to any individual patient encounter, as desired. In such an embodiment, the caregiver could dictate into a simple digital, hand-held recorder, and the staff could download the dictation as an MP3 file (or other compressed audio file) associated with that patient's unique visit for that day. Alternately, the doctor can dictate his encounter notes directly into the file, himself, using a microphone associated with the Doctor's computer. The system can adapt such an audio file into a digital file using an audio interface commonly accessible through many standard operating systems, or even through a customized audio solution. The system would allow attachment of patient and visit codes to the audio file in order to permanently associate the file with the visit/patient, and files could be accessed using a standard audio player. An audio file associated with a patient/visit, could be routed to any station for auditing, or to a transcription service for hard copy turnaround. Additionally, in one particular embodiment of the system, the physician has the option of utilizing the transcription service provided by a company, such as Hybrid Medical Record Systems Inc., for a fee. As a result, the instant invention would drastically reduce dictation costs by allowing only the dictation deemed necessary to be sent for transcription, yet maintaining dictation in a database for as-needed retrieval.

In summary, in one particularly preferred embodiment of the present invention, an automated records system is provided that is programmed to perform certain functions including, but are not limited to:
1) Guiding/assisting the doctor in providing patient care while making sure the documentation reflects what actually occurred during a patient encounter with the least amount of writing.
2) Ensuring that there is consistency between what is documented in the progress note and the diagnosis the doctor makes.
3) Ensuring that the documentation of a patient encounter is sufficiently detailed, so it reflects the doctor's experience, training, and state of the art standard of care.
4) Providing the doctor with a document that will ensure proper payment for her time spent with the patient.
5) Reminding the doctor about tests or actions that are due for the patient in an alarm clock fashion, in order to help the provider stay in accordance with nationally established standards.
6) Allowing attachment of a unique audio dictation file to the patient record for each encounter. This can be easily captured and flexibly routed to avoid the untoward expense and cumbersome logistics of traditional dictation and transcription.
7) Providing a paper copy of medical records stored electronically, to facilitate the workflow of multiple office personnel who need the patients' charts to work.
8) Maintaining an original, ink-and-paper version of the unique patient encounter to ensure reliable care, legal documentation, and accurate evidence of individual gold-standard treatment of each patient at each encounter.

The use of both a paper copy of a patient's chart, and an electronic copy of the patient's chart, can provide distinct advantages in a medical setting. A paper-only chart can only be in one place at a time. The electronic-only chart is an emerging, yet problematic, form of documentation. Several technological hurdles in the form of hardware (battery technology, etc.) and software (voice recognition of rapid speech, customization and flexibility, for example) render existing systems suboptimal. Pull-down menu, touch-screen templates can be used to record elementary notes. The integrated medical records generated by the system and method of the present invention addresses the statutory requirements for documentation, via the retention of paper charts, yet allows for flexible, multi-access electronic records efficiencies beyond those currently available.

The system of the present invention can be programmed to provide the users with an interface to enter the information regarding each patient. For example, the system of the invention can be programmed to display the following interactive screens, and/or other screens that permit the entry of the information into the system for generating customized forms and maintaining the information recovered from the completed customized forms.

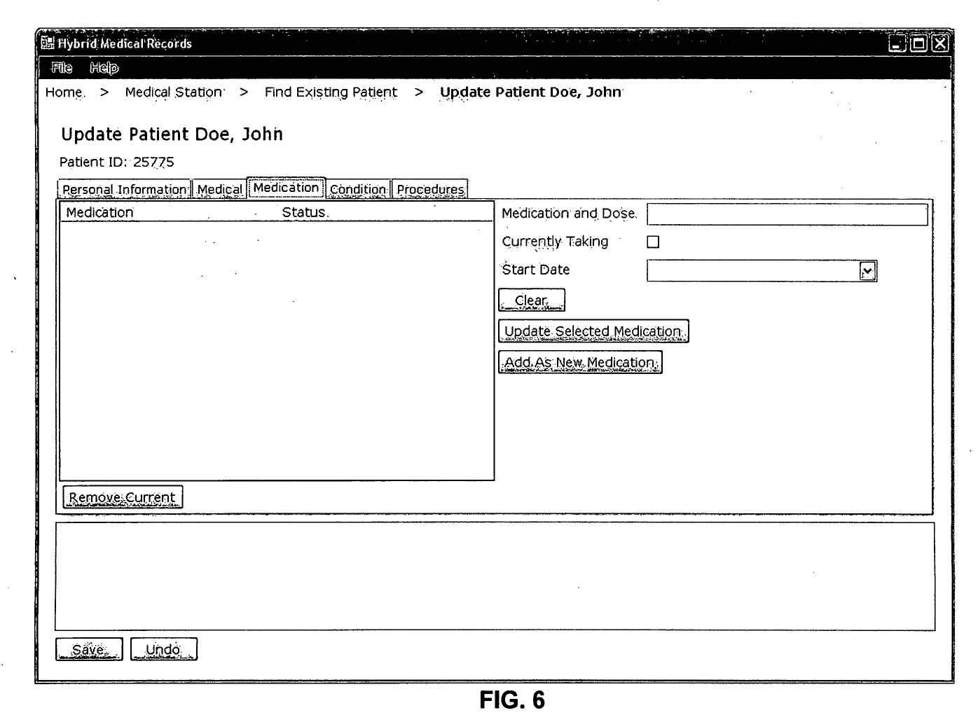

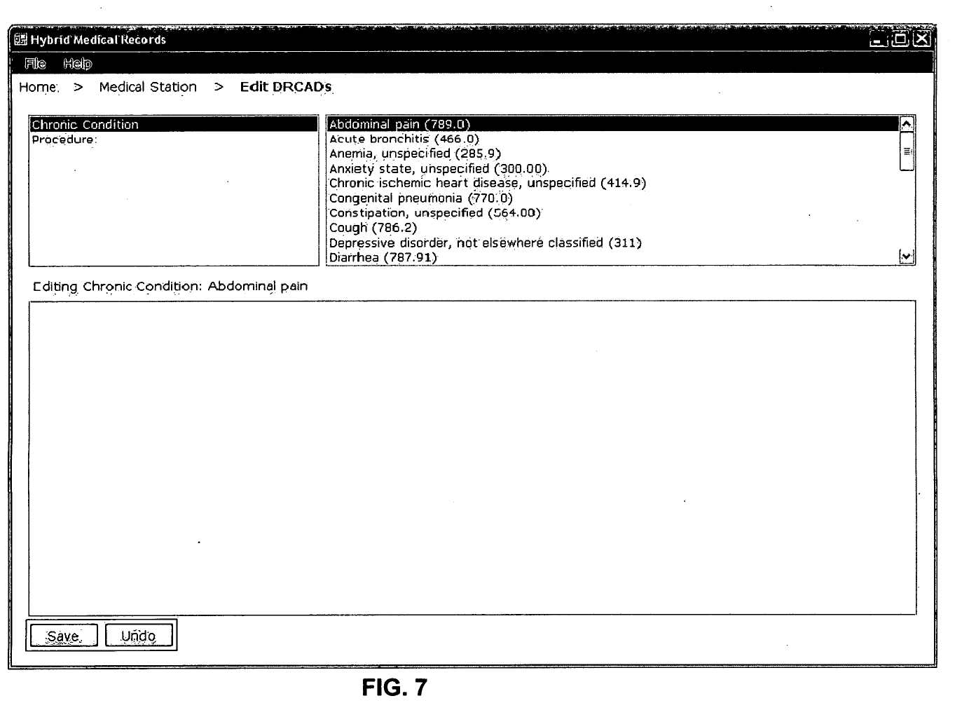

For example:
1) At patient check-in, office personnel can input patient demographics, print up progress notes, Superbills, and Medications and Problems Sheets. Suitable screens for entering such information are shown in FIGS. 3-5. Additionally, if desired, the system software can include a module that will permit scanning of patient history forms, to convert the information therein to records in the patient's electronic chart, in accordance with the methods described herein.
2) Checkout will scan in the progress note using an ordinary computer scanner. This is the minimum function. This action will mirror the progress note in the computer and trigger content enriched electronic medical records. The receptionist will also scan in the Medications and Problems Sheet if it has been altered. This should be routed to whoever the office deems responsible to update problem lists and medication lists.
3) Doctor/Nurse/billing screen will allow the office personnel to perform handwriting recognition and update problem lists and medication lists. The inbox is updated after the scanning in of a Medications and Problems Sheet. The output causes the Medications and Problems Sheets to be updated at the next patient visit (reception will be alerted) and the progress note to be updated (by adding more bubble areas of chronic diagnoses). An example of a suitable user interface computer screen for entering/providing this information is shown in FIG. 6.
4) The Alarm Clock Screen is set by the medical director (meaning one standard per office). He/she will choose the name of the alert and the patient parameters (i.e., system rules) associated with that name, for example:
   a. PAP for FEMALES 20 to 30 years old EVERY 2 YEARS
   b. FEMALES 30 to 70 years old every year
   c. MAMMOGRAM for FEMALES 35 to 40 years every 2 years, 40 to 80 years old every year.
   d. LABS for MALES and FEMALES 10 to 100 years old every year.
   e. CHEST XRAY for SMOKERS age 10 to 100 every year.
   f. EKG for MALES and FEMALES age 40 to 100 OR SMOKERS age 10 to 100. ETC
5) Individual Health Care Provider Screen that will allow the individual health care provider to set up his or her MICRO NOTES. This could range from none to large and numerous macros for the physician interested in providing thorough education and explanation of the chosen treatment plan to each patient. Such a user interface screen suitable for entering/providing this information is shown in FIG. 7.

### Billing Station:

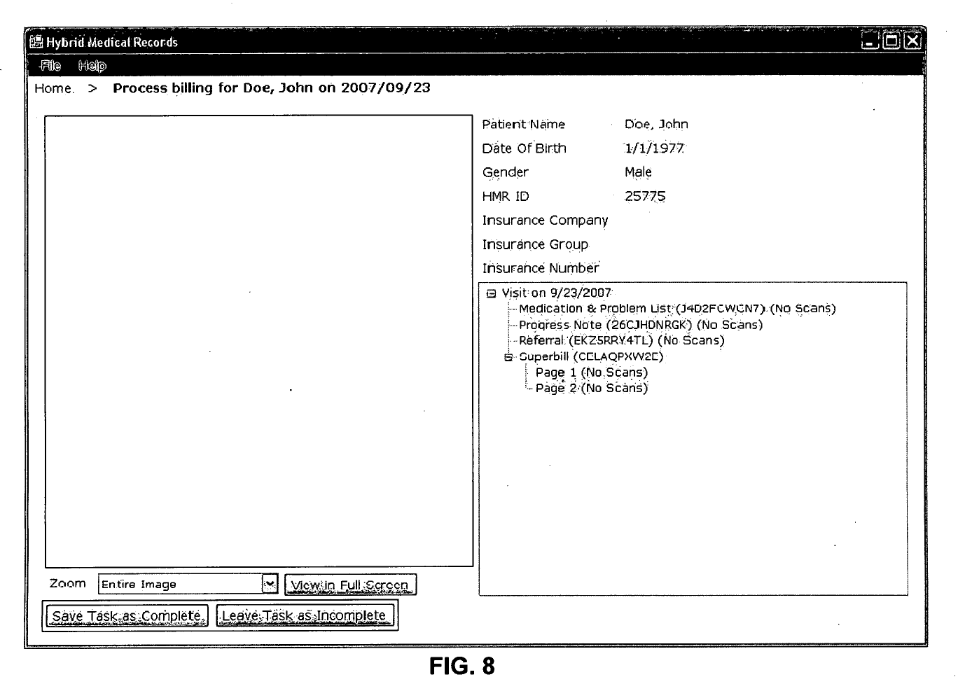

As discussed above, the system software of the present invention can additionally include modules for entering the information necessary for generating billing information and/or for generating a Superbill. One such exemplary graphical user interface screen for use by office personnel in inputting the information useful for preparing a bill is shown in FIG. 8.

As can be seen from the foregoing the system and method of the present invention make information highly accessible and organized without fundamentally changing what happens in the exam room, the invention enhances the efficiency of the medical office operation and improves physician performance in terms of accuracy and time management. The use of such a system and method in accordance with the invention is invisible to the patient, while permitting the physician to treat patients without having to relearn how to document patient encounters. The resulting medical records are stored electronically, which enhances information sharing, thus improving the efficiency of every member of the medical team.

### TRANSPORTABILITY TO OTHER INDUSTRIES

This system would lend itself to myriad other industries with minor adjustment. Examples as follows:

Public safety—Any crime scene, accident scene, fire scene or encounter that requires documentation and electronic distribution of information is an ideal application of the system. Forms would be generated to reflect common causes/conditions/outcomes/scenarios that could be further clarified by handwritten commentary. The distribution of the recorded information could generate a report that is instantaneously sent to supervisors, or automatically enter a queue for correction and editing upon arrival back at the station.

Voting—a paper copy of each vote would be kept for a recount situation or redundant vote counting system. Upon scanning, each individual race would be tallied separately and the voter could actually keep the ballot for record-keeping purposes.

Auto repair—Forms would be generated to reflect common procedures and outcomes. Scanned records would distribute data to the billing/checkout area, the parts department for ordering and fulfilling purposes, and the central control for workflow management.

Dentistry—Dentists would use the system in a virtually identical fashion as medical practitioners. Statins would include hygienist, lab, checkout, and billing.

Corrections—Inmate encounters from booking to parole evaluation could be captured on standardized forms, with the information distributed to hospitals, supervisors, municipality law enforcement, federal law enforcement or investigations departments.

Education—Student encounters by counselors, admissions personnel, administrators, or teachers can be captured on the system's paper input. The information could be distributed to the local board of education, parents, administrators, teaching group leaders, school psychologists, or any interested party.

Sales—Reps could capture the information from a specific sales call (what was discussed, what questions came up, what commitments were made, etc.) and have that information transported to managers, their CRM software, and home office.

While the invention has been described with reference to certain embodiments, it will be understood by those skilled in the art that various changes may be made and equivalents may be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A system for managing medical information of a patient, comprising:
a computer programmed to receive information associated with the patient;
said computer being programmed to generate from said received information, at least one form customized to the patient, for use during the examination of the patient, said form including at least one area for receiving an annotation and a dedicated field associated with said at least one area;
a data entry interface, in communication with said computer, for entering information from said at least one form into the system after the form has been modified;
said computer being programmed to interpret said entered information to determine the presence or absence of an annotation in said at least one area, and, if present, to capture image data from said dedicated field; and
storing the entered information in a file associated with the patient.

2. The system of claim 1, wherein said data entry interface includes an optical scanner.

3. The system of claim 1, wherein said at least one area includes at least one of a check box, a blank and a bubble and said computer is programmed to make a binary determination of whether or not a mark has been made in said at least one check box, said blank or said bubble.

4. The system of claim 3, wherein said dedicated field is a different portion of said at least one form than a portion including said at least one check box, said blank or said bubble.

5. The system of claim 1, wherein said dedicated field is a portion of said at least one form not including said at least one area.

6. The system of claim 5, wherein said dedicated field is a blank portion of said at least one form.

7. The system of claim 1, wherein said at least one form includes at least another area not associated with a dedicated field.

8. The system of claim 7, wherein said computer is programmed to make a binary determination of whether or not an annotation has been made in said at least one area and to store information associated with the binary determination in a file associated with the patient.

9. The system of claim 8, wherein said computer is programmed to generate at least one form customized to the patient using said received information and said stored information.

10. The system of claim 7, wherein said computer is programmed to obtain image data from said at least one area and to automatically convert said image data into textual and/or numerical information.

11. The system of claim 10, wherein said computer stores both of the obtained image data of the at least another area and the converted textual and/or numerical information obtained from the at least another area in the file associated with the patient.

12. The system of claim 1, wherein said computer is programmed to break down said entered information into a plurality of components and to provide different ones of the plurality of components to different stations in the system based on the identity of each station and/or the specific office's workflow design.

13. The system of claim 1, wherein said computer is programmed to generate and patient-specific educational materials based on a determination that an annotation is present in the at least one area.

14. The system of claim 1, wherein said form includes a plurality of areas for receiving an annotation, said computer being programmed to generate patient-specific educational materials based on the presence or absence of annotations in the plurality of areas.

15. The system of claim 1, wherein said computer is programmed to generate at least one other patient-specific form including at least one area not associated with a dedicated field, said computer being programmed to make a binary determination of whether or not an annotation has been made in said at least one area not associated with a dedicated field.

16. The system of claim 15, wherein said determination is stored in the patient's file and used to generate at least one patient-specific form for use during a subsequent visit of the patient.

17. A system for managing medical information of a patient, comprising:
a computer programmed to receive information associated with the patient;
said computer being programmed to generate from said received information, at least one form customized to the patient, for use during the examination of the patient, said form including at least one area for receiving an annotation;
a data entry interface, in communication with said computer, for entering information from said at least one form into the system after the form has been modified;
said computer being programmed to break down said entered information into a plurality of components and to automatically provide at least one of said plurality of component to at least one station.

18. The system of claim 17, wherein different ones of said plurality of components are provided by the computer to different stations of the system based on the identity of each station.

19. A system for information of a customer, comprising:
a computer programmed to receive information associated with the customer;
said computer being programmed to generate from said received information, at least one form customized to the customer, for use while providing a service to said customer, said form including at least one area for receiving an annotation;
a data entry interface, in communication with said computer, for entering information from said at least one form into the system after the form has been modified;
said computer being programmed to break down said entered information into a plurality of components and to provide at least one component to at least one station.

20. The system of claim 19, wherein different ones of said plurality of components are provided to different stations in the system based on the identity of each station.

21. A method for processing patient information, comprising the steps of:
entering information specific to a patient into a computer;
generating, with the computer, at least one patient specific form for use during a patient encounter;
providing the at least one patient specific form to a medical professional for use during the patient encounter;
processing the at least one patient specific form, with the computer, to identify the presence of at least one annotation made in a first particular portion of the form as a result of the patient encounter;
capturing image data from a second particular portion of the form as a result of the identification of the presence of an annotation made in the first particular location of the form;
storing the captured image data in an electronic data record associated with the patient.

22. The method of claim 21, wherein, in the processing step, the computer breaks down the at least one patient-specific form into a plurality of components and automatically provides at least one of the plurality of components to at least one station, based on the identity of the station.

23. The method of claim 21, wherein the at least one patient-specific form additionally includes at least another area for receiving an annotation, said at least another area not being associated with a dedicated field.

24. The method of claim 21, wherein information derived from the form in the processing step is used by the computer to generate a subsequent patient-specific form for the patient.

25. The method of claim 21, wherein information derived from the form in the processing step is used by the computer to automatically generate patient-specific educational materials for the patient.
